(19) United States
(12) Patent Application Publication
(10) Pub. No.: US 2026/0178306 A1
(43) Pub. Date: Jun. 25, 2026

(54) SOFTWARE PROVISIONING SYSTEM PROMOTER

(71) Applicant: INTUIT INC., Mountain View, CA (US)

(72) Inventors: Michael CRENSHAW, Charlottesville, VA (US); Zach ALLER, Minot, ND (US); Alexandre GAUDREAULT, Chicoutimi (CA); Omer AZMON, Sunnyvale, CA (US); Vijay AGRAWAL, Sunnyvale, CA (US)

(21) Appl. No.: 18/991,950

(22) Filed: Dec. 23, 2024

(51) Int. Cl. G06F 8/65

(52) U.S. Cl. CPC G06F 8/65

(57) ABSTRACT

Aspects of the present disclosure relate to deploying changes to computing code. Embodiments include receiving, based on an input provided by a user: an input that specifies a first environment, a second environment, a given set of checks for the first environment, a first artifact for the first environment, and a second artifact for the second environment. Embodiments further include opening and merging a first pull request based on the first artifact. Embodiments further include opening a second pull request based on the second artifact. Embodiments further include merging the second pull request into the second environment based on the first environment passing the given set of checks.

### BACKGROUND

Every year a growing number of people, businesses, and organizations around the world utilize software promotion systems to develop and modify software applications. Software provisioning systems such as GitOps® may be used to implement changes to code in different staging branches (such as development, testing, and production environments, and/or the like) such as for automated management of infrastructure provisioning. For example, different software programming professionals may make various changes to software code in a development environment, and these changes may be tested in the test environment before being deployed, or promoted, into a user-facing production environment.

However, existing software promotion systems have met with numerous technical challenges. For example, software development projects can involve vast bodies of code. Developing or modifying the code may involve making extensive changes to the existing body of code, and each change may create a possibility for mistakes. Also, environment specific configurations may create additional possibilities for mistakes. As an example, a new version of code may pass all checks, or gates, in a development environment, but then fail one or more checks in a test environment. The failure may be the result of any of a multitude of changes that were made, and/or the failure may be due to the configuration of the test environment (or any changes thereto). As a result, identifying the problem and getting the code back to a state that functions properly can be an extremely complicated process that requires an extensive amount of time and resources. Furthermore, additional mistakes may be made in attempting to revert the code/configurations to a prior state. For example, the wrong change may be undone and/or a change that should be undone may not be undone. This may be further complicated by the interrelation between changes (e.g., one change may necessitate another change/reversion, one reversion of a change may necessitate another reversion/change, and/or the like)

Thus, there is a need in the art for improved techniques of deploying changes to computing code.

### BRIEF SUMMARY

Certain embodiments provide a method of deploying changes to computing code. The method generally includes: receiving, based on an input provided by a user: an input that specifies a first environment, a second environment, and a given set of checks for the first environment; a first artifact for the first environment; and a second artifact for the second environment; opening and merging a first pull request to move the first artifact to the first environment; opening a second pull request based on the second artifact; and merging the second pull request into the second environment based on the first environment passing the given set of checks.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned method as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to deploying changes to computing code.

FIG. 2 depicts an additional example of computing components related to deploying changes to computing code.

FIG. 3 depicts an example of a user interface for deploying changes to computing code.

FIG. 4 depicts an example of a repository for deploying changes to computing code.

FIG. 5 depicts example operations related to deploying changes to computing code.

FIG. 6 depicts an example of a processing system for deploying changes to computing code.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for deploying changes to computing code.

According to certain embodiments, a user may provide an artifact such as computing code (e.g., a change to an existing body of code, or a configuration that references a version of the code) to a promotion system. The user may also specify environments (e.g., multiple environments may correspond to a main branch, and a staging branch and a live branch may be created for each environment) in which the code should be implemented, as well as checks and configurations for the environments. Pull requests may be opened for each environment. A pull request may then be merged to implement the code in a first environment. Then, if the first environment passes the specified checks for the environment, a pull request may be merged to deploy the code in the second environment. If a new version of the code or a new configuration for one or more environments is submitted, the open pull requests may be updated and/or new pull requests may be opened to store the new code and/or configurations. Each of the new pull requests may be associated with a single identifier. Thus, if an environment is degraded and fails a check, the user may be able to revert to a previous artifact by selecting a previous identifier that is associated with an artifact that did not fail for the same environment.

Embodiments of the present disclosure provide numerous technical and practical effects and benefits. For example, techniques described herein greatly simplify code deployment processes by allowing users to automatically revert to a known failure-free state. This simplification is achieved, for instance, by storing the state of each environment for each code/configuration change in a pull request. Furthermore, by associating the state for all environments with a single identifier that is common for the artifacts in each environment, the entire promotion instance may be restored in the event that a subsequent change leads to a failure. Thus, instead of painstakingly sorting through historical changes to reconstruct a state in order to undo a change, users may revert to a prior state by selecting the common identifier associated with the state. This streamlined reversion process can greatly reduce the amount of time and computing resources associated with deploying software code. Also, simplifying the reversion process can greatly reduce the amount of mistakes made in software deployment.

### Example of Computing Components Related to Deploying Changes to Computing Code

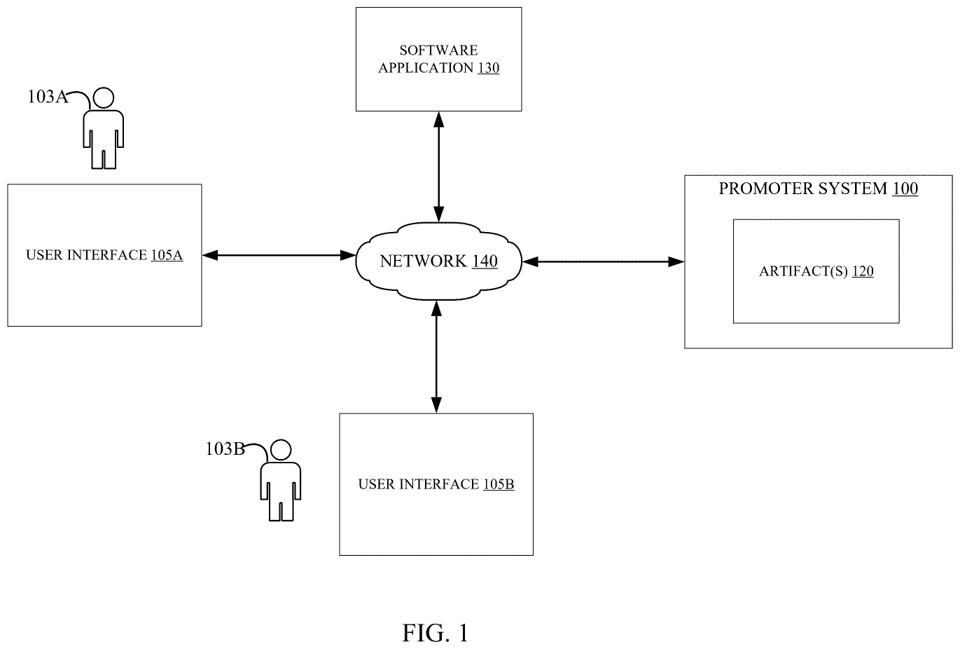

FIG. 1 depicts an example of computing components related to deploying changes to computing code.

A user 103A may interact with a software application 130 via a user interface 105A associated with a computing device. The software application 130 may generally be any type of software application. User 103B may be a developer of the software application. User 103B may interact with a promoter system 100 via a user interface 105B associated with a computing device. The promoter system 100 may be used to perform tasks related to development/modification of the software application 130. For example, the user 103B may use the promoter system 100 to deploy artifacts and update the software application 130. Once the updates are deployed, user 103A may use the updated software application 130. One or more computing components shown in FIG. 1 may use a network 140 (e.g., the Internet) to communicate with other components.

In certain embodiments, an artifact 120 may comprise computing code and/or configurations for particular environments, such as development environments, test environments, and production environments. A given configuration may contain a reference to a version of the computing code for which the configuration is used, and the version of the computing code may be retrieved and/or implemented based on the reference. According to some embodiments, artifacts 120 comprise other types of entities, such as machine learning models, images, and/or any other type of entity that can be promoted via a promoter system. For example, a machine learning model may be deployed in different environments according to embodiments disclosed herein.

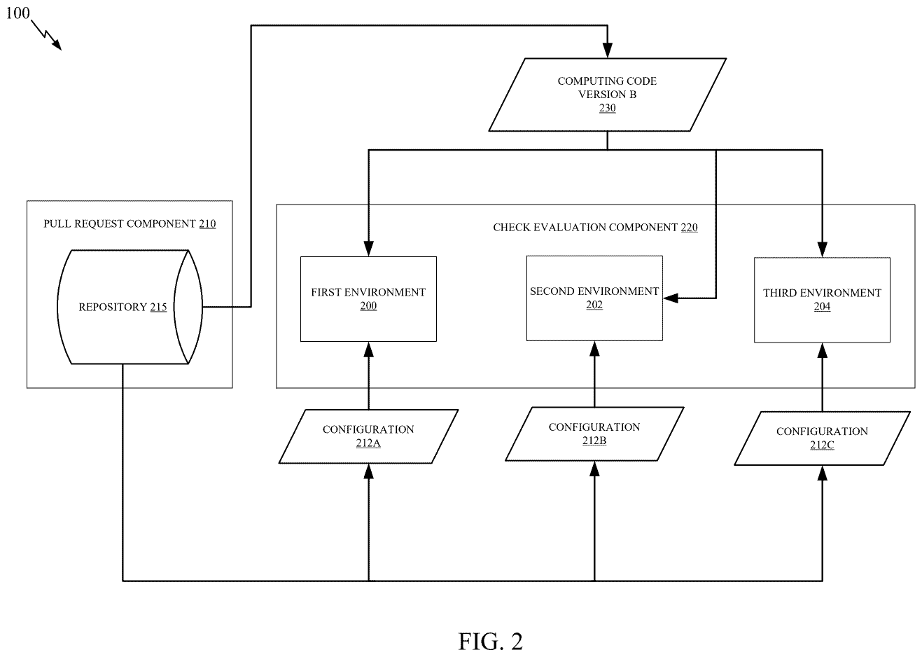

FIG. 2 depicts an additional example of computing components related to deploying changes to computing code. In particular, FIG. 2 depicts promoter system 100 of FIG. 1.

A pull request component 210 may be used to open, update, and merge pull requests. In an example pull request (e.g., a Git pull request or other software deployment system pull request), code changes and/or configuration changes are stored in a repository (e.g., a Git repository or other software deployment system repository) based on the pull requests. If the changes are approved, the pull request may be merged, meaning that the changes are deployed into the target environment.

In the example shown in FIG. 2, a user has made a change to computing code and/or a configuration, such as an environment-specific configuration. The user may have also specified environments in which the code should be deployed/tested. Here, the user has specified first environment 200, second environment 202, and third environment 204. Staging branches may be opened for each of the environments, and each staging branch may be populated with a reference to the latest common identifier from a main branch as well as the environment-specific configurations corresponding to the common identifier. First environment 200 may be the development environment, second environment 202 may be the test environment, and third environment 203 may be the production environment (e.g., software application 130 of FIG. 1). Other combinations and types of environments may be used, and more or fewer environments may be used. As discussed in further detail below, each of the environments specified by the user may be hydrated according to configurations provided by the user as well as updated code provided by the user and checks provided by the user. Thus, embodiments disclosed herein allow for declarative promotion of software code.

Upon receiving the change(s), the promoter system 100 may invoke the pull request component 210. The pull request component may open pull requests for each of the environments. Each pull request may store the version of the computing code and the configuration for the respective environment in a source code management branch comprising a repository 215. For example, the code change may be entered into a user interface, and a pull request may store the code in the repository 215.

As shown in FIG. 2, the user has provided a new version of code for a software application, computing code version B 210. Also the user has provided configurations for each of the computing environments. Configurations may include, for example, a number of instances of the code running in a particular environment, an amount of memory allocated for the code in a particular environment, and/or the like. For a given promotion instance, the same version of the software code may be used for each environment. Configurations may be unique to each environment (although, in some embodiments, environments may have the same configurations). Thus, a given configuration artifact for a particular environment may comprise the code that is deployed in all environments along with the configuration that is specific to the particular environment.

The pull request for the first environment 200 may be merged, and the check evaluation component 220 may run the specified checks on the first environment 200. Checks are generally tests used to determine whether code and/or configurations should be deployed in an environment. Checks may also be referred to as gates, since the checks may be used to determine whether the code/configurations pass through to an environment. Examples of checks include checks for whether a deployment freeze is in effect, checks for whether a prerequisite environment is synced, checks for whether a prerequisite environment is healthy (e.g., the environment is free of errors, failures, and/or the like), checks for whether a lead developer has approved a change, and/or the like. Checks may be provided by users or selected by users from a list of predefined checks. Merging the pull request for the first environment 200 may result in deployment of computing code version B 230 and configuration 212A in the first environment 200. In some embodiments, merging the pull request for the first environment 200 may be contingent on a set of checks for the first environment 200 being passed (e.g., a check to see whether a deployment freeze is in effect and/or the like). As discussed in further detail below, a given environment may be degraded (e.g., the given environment may fail a check, for example, because one or more errors, failures, and/or the like are present in the environment). In embodiments where the health of the given environment is a prerequisite for merging a pull request into another environment, the pull request may not be merged if the given environment is degraded.

Check evaluation engine 220 may run the checks for the first environment 200. If the first environment 200 passes the checks (e.g., the first environment 200 is not degraded), the pull request for the second environment 202 may be merged. Merging the pull request for the second environment 202 may result in deployment of computing code version B 230 and configuration 212B in the second environment 202. In some embodiments, merging the pull request for the second environment 202 may be contingent on a set of checks for the second environment 202 being passed (e.g., a check to see whether a deployment freeze is in effect and/or the like).

Check evaluation engine 220 may run the checks for the second environment 202. If the second environment 202 passes the checks, the pull request for the third environment 204 may be merged. Merging the pull request for the third environment 204 may result in deployment of computing code version B 230 and configuration 212C in the third environment 204. In some embodiments, merging the pull request for the third environment 204 may be contingent on a set of checks for the third environment 204 being passed (e.g., a check to see whether a deployment freeze is in effect and/or the like).

If a user submits a new change and/or configuration during promotion, new pull requests may be opened for environments without an open pull request and each of the open pull requests may be updated based on the new change/configuration. For example, computing code version B 230 may have passed all checks for the first environment 200, and the pull request for the second environment 202 may have been merged. Then, the user may have submitted a new change to the code, computing code version C (or, the user may have submitted a new configuration that references computing code version C). The pull requests may be opened/updated. For example, after the updates, each pull request may include computing code version C and the configuration for the respective environment. The contents of the three pull requests may be associated with a common identifier (e.g., a Git commit hash or other software deployment system identifier such as a commit hash, or commit identifier). Thus, if the user submits computing code version D and a failure occurs, the user may revert to computing code version C along with the configurations that were used for the respective environments when computing code version C was implemented. Reversion to a previous state may occur automatically, or based on user input (e.g., based on a user selecting a previous state, or based on the user manually merging an automated pull request that has been automatically updated according to a prior failure-free state).

It is noted that while the example shown in FIG. 2 depicts three environments, more environments or fewer environments may be used.

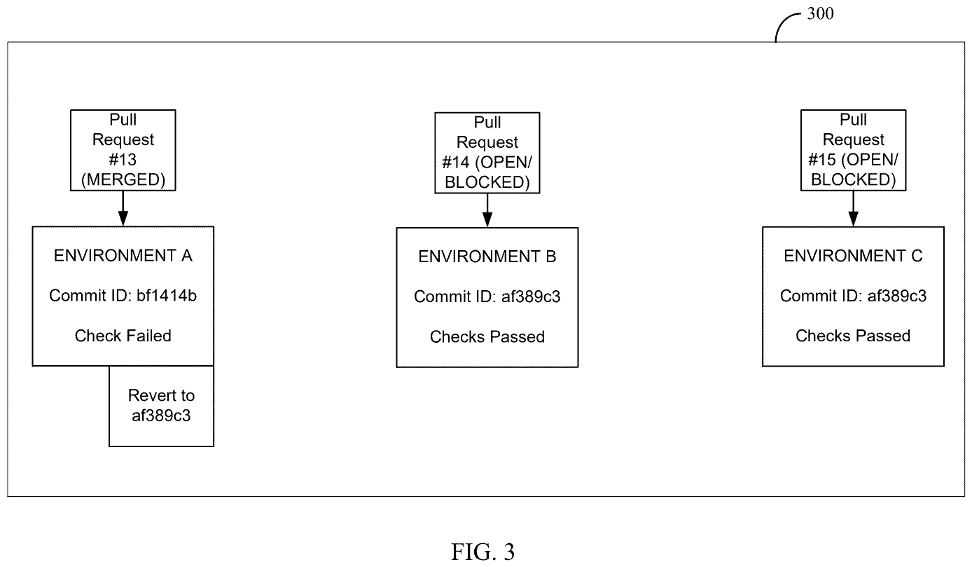

FIG. 3 depicts an example of a user interface 300 for deploying changes to computing code.

The user interface 300 shows different environments involved in the promotion process. For each environment, the commit identifier is shown along with the check status. As shown in FIG. 3, Environment B and Environment C are both still on the previous commit, meaning that the most recent change has not been merged into these environments. The last merged change for Environment B was associated with commit identifier af389c3 and was merged by Pull Request #11 (not shown), which has been merged and is thus no longer open. The last merged change for Environment C also was associated with commit identifier af389c3 and was merged by Pull Request #12 (not shown), which has also been merged and is thus no longer open. Pull request #13 was opened based on the most recent change (which is associated with commit identifier bf1414b) and merged to deploy the most recent change to Environment A.

Pull Requests #10, #11, and #12 (not shown) are previously merged pull requests that were used to merge the prior change. Each of these pull requests is associated with a common commit identifier, af389c3. Each of the environments passed the checks when the prior change was deployed. Pull Requests #13, #14, and #15 have been opened based on the most recent change. Pull Request #13 has been merged, but Pull Requests #14 and #15 have been blocked due to Environment A failing a check, and have thus not been merged.

The most recent change was merged into Environment A when Pull Request #13 was opened and merged, as discussed above. As shown, Environment A failed a check when this change was deployed. As a result, the user is presented with an option to revert to af389c3, the commit identifier associated with the last healthy state (e.g., the state that passed all checks). If the user chooses to revert to this state, Pull Request #14 and Pull Request #15 may be updated based on the respective environment-specific configurations associated with commit identifier af389c3 and merged into the respective environments. A new pull request, Pull Request #16 (not shown), may be opened based on the Environment A-specific configurations associated with commit identifier af389c3 and merged into Environment A. In some embodiments, the user interface may provide users with a list of commit identifiers from which a selection may be made. For example, commit identifiers af389c3 (associated with the last healthy state) and commit identifier bf1414b (the common identifier associated with the last state) may be included in the list. In some embodiments, the pull requests may be automatically updated according to the last error-free state (or automatically updated to a state selected by the user) and the user may manually merge the pull requests.

By opening/updating pull requests for each environment in response to a change and only having one open pull request at a time for each environment, embodiments disclosed herein greatly simplify the promotion process and conserve processor resources. For example, because fewer pull requests will be open at any given time, all pull requests may be neatly updated and organized based on the most recent change. Thus, “mixed” states that include separate versions of the same code and/or configurations that were used for separate versions in different environments may be avoided, and the promotion process may be greatly simplified.

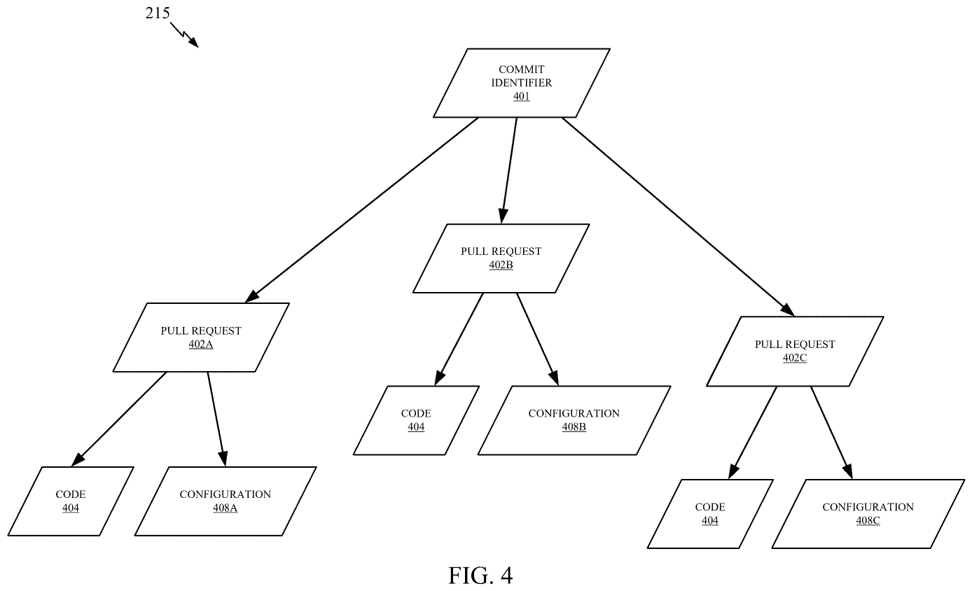

FIG. 4 depicts an example of a repository 215 for deploying changes to computing code. The repository 215 may be a repository associated with a source code management branch of the promotion system.

The repository 215 may contain a plurality of promotion instances. Each promotion instance may include a common identifier, such as commit identifier 401 that is used to identify the instance and allow for reversion to the instance.

The instance may further comprise artifacts stored by pull requests for each environment, such as pull requests 402A, 402B, and 402C. Pull request 402A may be a pull request for a first environment, pull request 402B may be a pull request for a second environment, and pull request 402C may be a pull request for a third environment. Each artifact may include code 404 (or a reference to code 404), which is the version of the computing code deployed in each environment in the promotion instance. Each artifact may also contain a respective configuration 408, which is the configuration used for the environment associated with the environment's pull request. In some embodiments, the configuration 408 contains a reference to the code version, and the code version is retrieved based on the reference. For example, pull request 402C may have been used to merge the code 404 and configuration 408C into a third computing environment of three computing environments. Configuration 408C may have been the configuration used for the third computing environment, configuration 408A may have been the configuration used for the first computing environment, and configuration 408B may have been the configuration used for the second computing environment. Code 404 may have been deployed in each computing environment. Each artifact may be associated with commit identifier 401, the common identifier for the promotion instance that is used to identify the entire promotion instance so that reversions may be performed.

### Example Operations Related to Deploying Changes to Computing Code

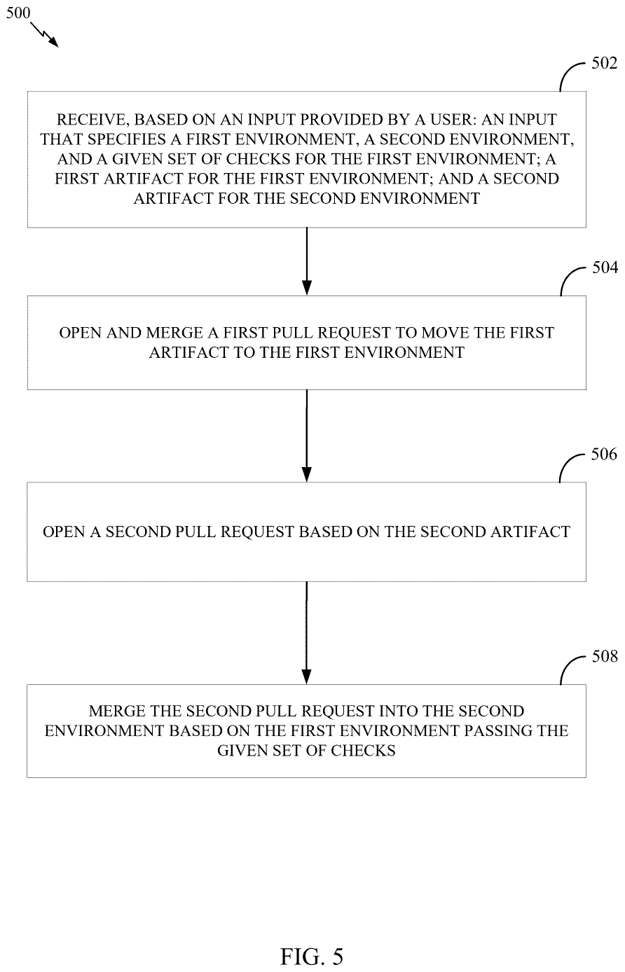

FIG. 5 depicts example operations 500 related to deploying changes to computing code. For example, operations 500 may be performed by one or more of the components described with respect to FIG. 1 and FIG. 2.

Operations 500 begin at step 502 with receiving, based on an input provided by a user: an input that specifies a first environment, a second environment, and a given set of checks for the first environment; a first artifact for the first environment; and a second artifact for the second environment.

Operations 500 continue at step 504 with opening and merging a first pull request to move the first artifact to the first environment.

Operations 500 continue at step 506 with opening a second pull request based on the second artifact.

Operations 500 continue at step 508 with merging the second pull request into the second environment based on the first environment passing the given set of checks. According to certain embodiments, merging the second pull request is further based on the second environment passing a particular set of checks. In certain embodiments, a user interface displays a status of each respective environment. Some embodiments provide that the status of each respective environment comprises an indication of whether each respective environment has passed a check. Certain embodiments provide that the user interface presents the user with an option to revert an environment to a previous version based on the environment failing a check.

According to some embodiments, an additional set of checks is received for the second environment, wherein the first environment and second environment are reverted to a previous version based on the second environment failing one or more checks of the additional set of checks. Certain embodiments provide that the previous version is a version that resulted in the second environment passing the additional set of checks. Some embodiments provide that the previous version comprises a previous version of first artifact and a previous version of the second artifact. In certain embodiments, the previous version of first artifact and the previous version of the second artifact are stored in a repository and associated with a common identifier, wherein the previous version of the first artifact and the previous version of the second artifact are retrieved based on the identifier, wherein the previous version of the first artifact is merged into the first environment and the previous version of second artifact is merged into the second environment.

According to certain embodiments, all open pull requests are updated based on receiving a new version of the first artifact or a new version of the second artifact.

Some embodiments provide that a particular set of checks is provided for the second environment and a third pull request is opened and merged into a third environment based on the second environment passing the additional set of checks.

### Example of a Processing System for Deploying Changes to Computing Code

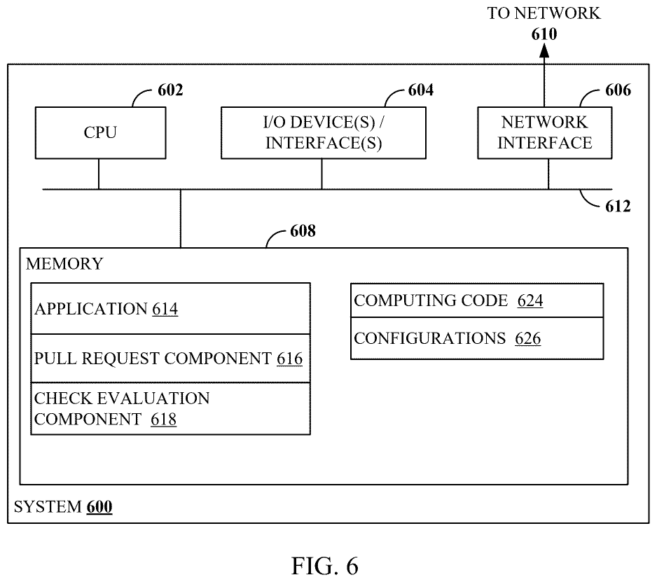

FIG. 6 illustrates an example system 600 with which embodiments of the present disclosure may be implemented. For example, system 600 may be configured to perform operations 500 of FIG. 5 and/or to implement one or more components as in FIG. 1 or FIG. 2.

System 600 includes a central processing unit (CPU) 602, one or more I/O device interfaces that may allow for the connection of various I/O devices 604 (e.g., keyboards, displays, mouse devices, pen input, etc.) to the system 600, network interface 606, a memory 608, and an interconnect 612. It is contemplated that one or more components of system 600 may be located remotely and accessed via a network 610. It is further contemplated that one or more components of system 600 may comprise physical components or virtualized components.

CPU 602 may retrieve and execute programming instructions stored in the memory 508. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 608 includes application 614, pull request component 616, and check evaluation component 618. Application 614 may be representative of software application 130 of FIG. 1. In some embodiments, pull request component 616 may be representative of pull request component 210 of FIG. 2. Check evaluation component 618 may be representative of check evaluation component 220 of FIG. 2.

Memory 608 further comprises computing code 624, which may correspond to computing code version B 230 of FIG. 2 or computing code 120 of FIG. 1. Memory 608 further comprises configurations 626 which may correspond to configurations 212A, 212B, and 212C of FIG. 2.

It is noted that in some embodiments, system 600 may interact with one or more external components, such as via network 610, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of deploying changes to computing code, comprising:
receiving, based on an input provided by a user:
an input that specifies a first environment, a second environment, and a given set of checks for the first environment;
a first artifact for the first environment; and
a second artifact for the second environment;
opening and merging a first pull request to move the first artifact to the first environment;
opening a second pull request based on the second artifact; and
merging the second pull request into the second environment based on the first environment passing the given set of checks.

2. The method of claim 1, further comprising receiving an additional set of checks for the second environment, wherein the first environment and second environment are reverted to a previous version based on the second environment failing one or more checks of the additional set of checks.

3. The method of claim 2, wherein the previous version is a version that resulted in the second environment passing the additional set of checks.

4. The method of claim 2, wherein the previous version comprises a previous version of first artifact and a previous version of the second artifact.

5. The method of claim 4, wherein the previous version of first artifact and the previous version of the second artifact are stored in a repository and associated with a common identifier, wherein the previous version of the first artifact and the previous version of the second artifact are retrieved based on the common identifier, wherein the previous version of the first artifact is merged into the first environment and the previous version of second artifact is merged into the second environment.

6. The method of claim 1, further comprising updating all open pull requests based on receiving a new version of the first artifact or a new version of the second artifact.

7. The method of claim 1, further comprising receiving a particular set of checks for the second environment, wherein a third pull request is opened and merged into a third environment based on the second environment passing the additional set of checks.

8. The method of claim 1, wherein a user interface displays a status of each respective environment.

9. The method of claim 8, wherein the status of each respective environment comprises an indication of whether each respective environment has passed a check.

10. The method of claim 8, wherein the user interface presents the user with an option to revert an environment to a previous version based on the environment failing a check.

11. The method of claim 1, wherein merging the second pull request is further based on the second environment passing a particular set of checks.

12. A system for deploying changes to computing code, comprising:
one or more processors; and
a memory comprising instructions that, when executed by the one or more processors, cause the system to:
receive, based on an input provided by a user:
an input that specifies a first environment, a second environment, and a given set of checks for the first environment;
a first artifact for the first environment; and
a second artifact for the second environment;
open and merge a first pull request to move the first artifact to the first environment;
open a second pull request based on the computing code and the second set of configurations; and
merge the second pull request into the second environment based on the first environment passing the given set of checks.

13. The system of claim 12, wherein the instructions further cause the system to receive an additional set of checks for the second environment, wherein the first environment and second environment are reverted to a previous version based on the second environment failing one or more checks of the additional set of checks.

14. The system of claim 13, wherein the previous version is a version that resulted in the second environment passing the additional set of checks.

15. The system of claim 13, wherein the previous version comprises a previous version of the first environment and a previous version of the second environment.

16. The system of claim 15, wherein the previous version of first artifact and the previous version of the second artifact are stored in a repository and associated with a common identifier, wherein the previous version of the first artifact and the previous version of the second artifact are retrieved based on the common identifier, wherein the previous version of the first artifact is merged into the first environment and the previous version of second artifact is merged into the second environment.

17. The system of claim 12, wherein the instructions further cause the system to update all open pull requests based on receiving a new version of the first artifact or a new version of the second artifact.

18. The system of claim 12, wherein the instructions further cause the system to receive a particular set of checks for the second environment, wherein a third pull request is opened and merged into a third environment based on the second environment passing the additional set of checks.

19. The system of claim 12, wherein a user interface presents the user with an option to revert an environment to a previous version based on the environment failing a check.

20. A non-transitory computer-readable medium comprising instructions that, when executed by one or more processors of a computing system, cause the computing system to:
receive, based on an input provided by a user:
an input that specifies a first environment, a second environment, and a given set of checks for the first environment;
a first artifact for the first environment; and
a second artifact for the second environment;
open and merging a first pull request to move the first artifact to the first environment;
open a second pull request based on the second artifact; and
merge the second pull request into the second environment based on the first environment passing the given set of checks.
